(19) United States
(12) Patent Application Publication
(10) Pub. No.: US 2012/0195216 A1
(43) Pub. Date: Aug. 2, 2012

(54) SYSTEMS AND METHODS FOR ADAPTIVE CHANNEL ACCESS

(75) Inventors: Jia-Hao WU, Guishan Township (TW); Yu-Tao Hsieh, Hsinchu City (TW); Chung-Pao Chen, New Taipei City (TW); Pang-An Ting, Taichung City (TW)

(73) Assignee: Industrial Technology Research Institute

(21) Appl. No.: 13/341,620

(22) Filed: Dec. 30, 2011

Related U.S. Application Data
(60) Provisional application No. 61/438,113, filed on Jan. 31, 2011.

(51) Int. Cl. H04W 72/04; H04W 24/00; H04L 12/26

(52) U.S. Cl. 370/252

(57) ABSTRACT

A base station and method for adaptive channel access in a wireless network are provided. The base station assigns a channel access scheme for providing channel access to service data, wherein at least a portion of the service data is assigned to one of a reserved shared channel access scheme and a superimposed channel access scheme based on one or more characteristics of the network and one or more requirements of the service data. Network resources are then allocated according to the assigned channel access scheme. The service data is then transmitted using the allocated resources.

### FIELD

The present disclosure relates to systems and methods for adaptively controlling channel access in a network based on network characteristics and/or requirements of data for transmission.

### BACKGROUND

Use of communication networks for transmitting and receiving information has increased in recent years, and is expected to increase for the foreseeable future. Many factors have led to this increased use. Firstly, technological advances have continued to reduce the cost of communication devices, leading to their widespread ownership and usage. Secondly, as the world continues to globalize, there is an increasing need for devices capable of quickly communicating information across large distances. These technological and cultural advances have led to such great usage of these devices that available network resources for communicating information are often strained. Nevertheless, new and exciting communication technologies continue to be introduced, with the potential for broad application in people's lives.

As use of communication networks has grown, communication techniques based on multiple subcarriers, such as orthogonal frequency-division multiplexing (OFDM) and orthogonal frequency-division multiple access (OFDMA), have gained in popularity, due to their broad applications. FIG. 1 illustrates a frequency plot of how OFDM uses a plurality of closely-spaced orthogonal subcarriers 101 to transmit data. OFDM provides many subcarriers 101 to modulate data on, thereby increasing data throughput. A number of evenly spaced subcarriers 101 are grouped into a channel for transmitting data. Nevertheless, OFDM only allows one user on a channel at any given time.

OFDMA is a multi-user OFDM that allows multiple users to access the same channel at the same time. FIG. 2 illustrates a frequency plot of OFDMA which shows how OFDMA breaks a signal into groups of subcarriers called sub-channels, and assigns to each user a group of sub-channels. In the example illustrated in FIG. 2, subcarriers 201 are grouped into one sub-channel and subcarriers 202 are grouped into another sub-channel. As illustrated by subcarriers 202 in FIG. 2, the grouping of subcarriers into a sub-channel need not group adjacent subcarriers into the sub-channel.

FIG. 3A illustrates an OFDM time-frequency resource allocation diagram 301. In OFDM, time-frequency resources are allocated at the subcarrier level. FIG. 3B illustrates an OFDMA time-frequency resource allocation diagram 302. In OFDMA, time-frequency resources are allocated on the sub-channel level, where sub-channels are groups of subcarriers. Time-frequency resource allocation may be discussed in units referred to as time-frequency resource units, where each time-frequency resource unit corresponds to the transmission resources of one subcarrier in a time slot, such as a time slot 303. Time-frequency resource units are grouped into channels and sub-channels, which may be referred to as time-frequency resource blocks. In OFDMA, groups of sub-channels can be assigned to each user in a way that mitigates problems with fading and interference based on the location and propagation characteristics of each user. OFDMA is expected to grow in popularity in the future, due to its flexible use of network resources.

Machine-to-machine (M2M) technology, sometimes referred to as machine-type communication (MTC) technology, is a newer communication technology that is expected to become more popular in coming years. M2M technology includes autonomous monitoring devices that communicate information. These technologies use a device, such as a sensor or meter, to capture an event, such as a temperature or inventory level. Information regarding the captured event is then relayed through a network to a software application. The software application translates the event into meaningful information that can be acted upon, such as restocking inventory when the information indicates that inventory is low. This technology is envisioned to have broad application in the fields of, for example, personal healthcare, traffic monitoring and control, criminal surveillance, smart control of power grids, and more. These technologies have particular use in wireless applications. Accordingly, practical applications of technologies such as these demand constant access to wireless communication networks. As such, high rate, high coverage, and high mobility cellular network systems are candidates to accommodate M2M service requirements, as well as the requirements of other new communication technologies. Wireless standards organizations, such as 3rd Generation Partnership Project (3GPP), 3rd Generation Partnership Project Version 2 (3GPP2), and Institute of Electrical and Electronics Engineers 802.16 (IEEE 802.16), are all launching new projects to support M2M services in their 4G standards.

FIG. 4 illustrates a conventional network structure 400 for M2M service applications. An M2M core network domain 401 bridges between M2M device traffic 402 and an application domain 403. The M2M core network domain 401 can include communication systems such as, for example, satellite, Wi-Fi, power line communication, cellular, and other systems.

According to marketing reports, the number of M2M cellular network connections are expected to grow to 187 million by year 2014. As the number of network connections continues to grow in number, the strain on cellular network resources will continue to increase. Nevertheless, it is desired that this increased strain not have an impact on original cellular users. As a result, there is a need for an efficient method for M2M devices and other devices to access communication channels provided by cellular networks with minimal impact on original cellular users.

### SUMMARY

In accordance with the present disclosure, there is provided a method for adaptive channel access in a wireless network, the method comprising: monitoring one or more characteristics of the wireless network; assigning, by a base station of the wireless network, a channel access scheme for providing channel access to service data, wherein at least a portion of the service data is assigned to one of a reserved shared channel access scheme and a superimposed channel access scheme based on the one or more characteristics of the network and one or more requirements of the service data; allocating resources of the network according to the assigned channel access scheme, wherein the resources are allocated in resource blocks; and causing the service data to be transmitted using the allocated resources.

Also in accordance with the present disclosure, there is provided a base station providing adaptive radio channel access in a wireless network, the base station comprising: a memory that stores instructions; and a processor that, when executing the instructions, is configured to: monitor one or more characteristics of the wireless network; assign a channel access scheme for providing channel access to service data, wherein at least a portion of the service data is assigned to one of a reserved shared channel access scheme and a superimposed channel access scheme based on one or more characteristics of the network and one or more requirements of the service data; allocate resources of the network according to the assigned channel access scheme, wherein the resources are allocated in resource blocks; and cause the service data to be transmitted using the allocated resources.

Further in accordance with the present disclosure, there is provided a method for adaptive radio channel access in a wireless network, the method comprising: monitoring one or more characteristics of the wireless network; assigning, by a base station of the wireless network, a channel access scheme for providing channel access to service data based on the one or more characteristics of the network and one or more requirements of the service data, wherein the assigning comprises: assigning the service data to one or more reserved and dedicated channels if the one or more network characteristics indicate sufficient bandwidth to transmit the service data on one or more reserved channels dedicated to a network device; and determining an alternative channel assignment if the one or more network characteristics indicate insufficient bandwidth to transmit the service data on one or more reserved channels dedicated to a network device, wherein the determining further comprises: assigning a portion of the service data to one or more reserved channels dedicated to a network device when the one or more requirements indicate that the portion of the service data has a priority greater than a determined threshold; and assigning a remainder of the service data to one of a reserved shared channel access scheme and a superimposed channel access scheme based on the one or more characteristics of the network and the one or more requirements of the service data; allocating resources of the network according to the assigned channel access scheme, wherein the resources are allocated in resource blocks; and causing the service data to be transmitted using the allocated resources.

Before explaining at least one embodiment of the disclosure in detail, it is to be understood that the disclosure is not limited in its application to the details of construction and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

The accompanying drawings, which are incorporated and constitute a part of the specification, illustrate certain embodiments of the disclosure, and together with the description, serve to explain the principles of the disclosure.

As such, those skilled in the art will appreciate that the conception upon which this disclosure is based may readily be utilized as a basis for designing other structures, methods, and/or systems for carrying out the several purposes of the present disclosure. It is important, therefore, to recognize that the claims should be regarded as including such equivalent constructions insofar as they do not depart from the spirit and scope of the present disclosure.

### BRIEF DESCRIPTION OF THE DRAWINGS

FIG. 1 illustrates a frequency plot of how OFDM uses a plurality of exemplary subcarriers to transmit data.

FIG. 2 illustrates a frequency plot of how OFDMA breaks a signal into exemplary groups of subcarriers called sub-channels, and assigns to each user a group of sub-channels

FIG. 3A illustrates an exemplary OFDM time-frequency resource allocation diagram.

FIG. 3B illustrates another exemplary OFDMA time-frequency resource allocation diagram.

FIG. 4 illustrates an exemplary network structure for M2M service applications.

FIG. 5 illustrates an exemplary wireless network environment in which one or more mobile stations and one or more additional communication devices coexist.

FIG. 6 illustrates an exemplary solution to transmission of data on a heavily loaded channel.

FIG. 7 illustrates exemplary radio channel access schemes of the present disclosure.

FIG. 8 illustrates an exemplary method for assigning radio channel access schemes.

FIG. 9 illustrates exemplary characteristics taken into account in assigning radio channel access schemes.

FIG. 10 illustrates an exemplary embodiment for superimposing M2M data on original mobile station data.

FIG. 11 illustrates an exemplary power spectrum density (PSD) of signals received by a base station.

FIG. 12 illustrates an example of selecting resource blocks on the basis of a number of forward error correction (FEC) codes in the resource blocks.

FIG. 13 illustrates an exemplary base station for transmitting and receiving data within a wireless network environment.

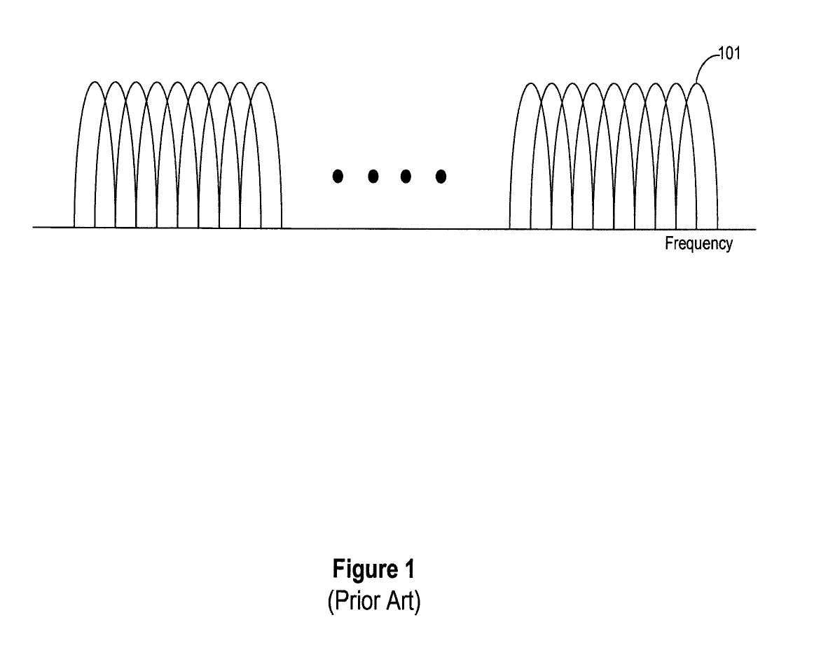

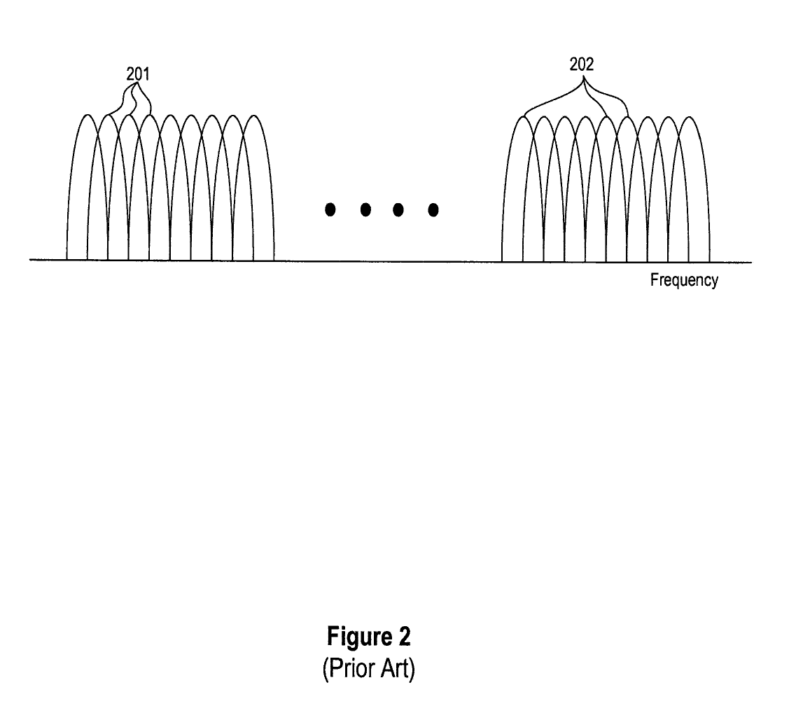

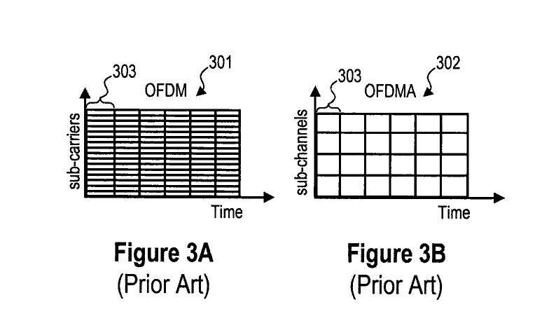

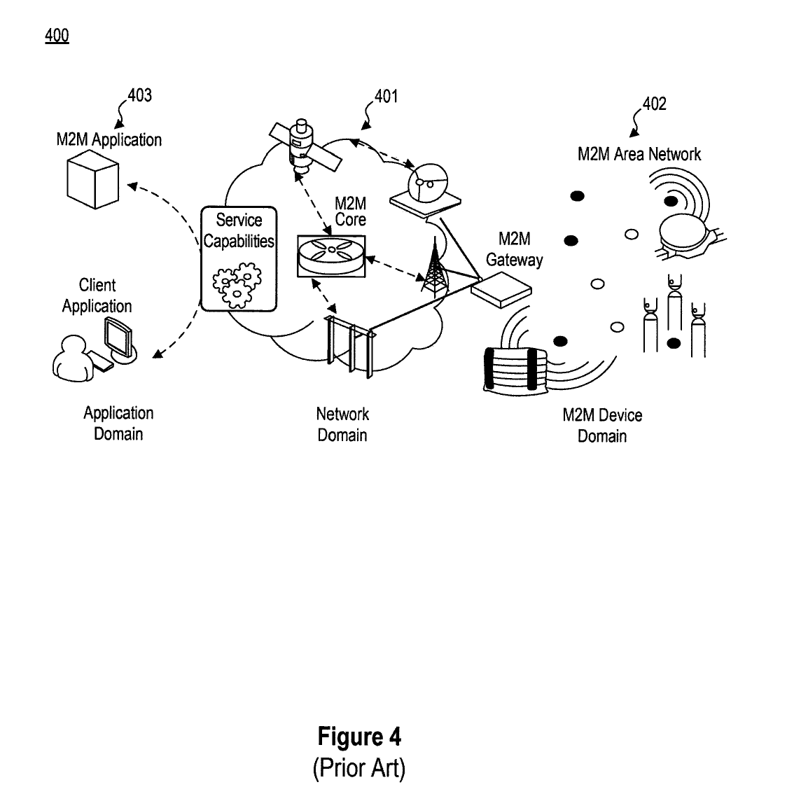

### DETAILED DESCRIPTION

Reference will now be made in detail to the present embodiments of the disclosure, certain examples of which are illustrated in the accompanying drawings.

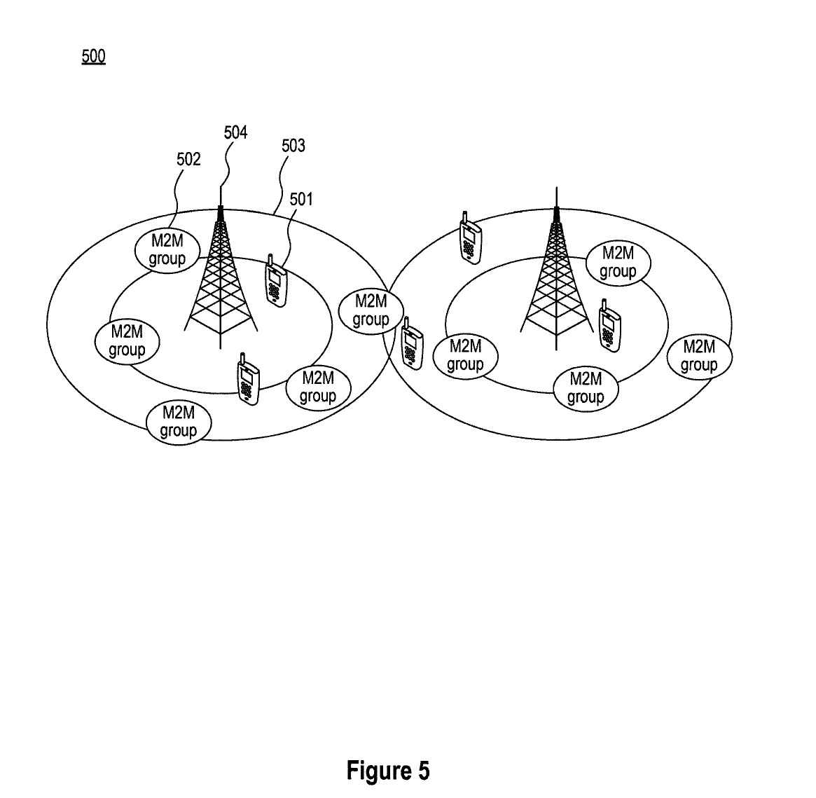

FIG. 5 depicts an exemplary embodiment of a wireless network environment 500. In environment 500, one or more mobile stations 501 and one or more additional devices 502 providing communication services may coexist and transmit data over a wireless network 503 via one or more base stations 504. In one exemplary embodiment, wireless network 503 is a cellular network, but the disclosure is not so limited. Mobile stations 501 may include, for example, mobile phones, smart phones, personal digital assistants (PDAs), laptop computers, tablet computers, netbooks, and/or other mobile devices capable of communicating over wireless network 503. Devices 502 may include any of the aforementioned types of mobile stations, and/or additionally may include stationary devices capable of communicating over wireless network 503. Devices 502 may provide a variety of communication services, including voice, video, emergency alert, and/or other data services. In one exemplary embodiment, illustrated in FIG. 5, communication devices 502 may include M2M or MTC communication devices. M2M devices may provide communication services that include communicating monitored events over wireless network 503. These events could include, for example, monitored inventory levels, temperatures, information related to traffic, health, crime, power grid, or any other type of information. Although devices 502 are referred to as M2M devices throughout the disclosure, the disclosure is not so limited. In one exemplary embodiment, information may be communicated over wireless network 503 using a protocol employing an OFDMA scheme, such as WiMAX. A Quadrature Amplitude Modulation (QAM) or Quadrature Phase-Shift Keying (QPSK) modulation scheme may be used for modulating data on subchannels of an OFDMA signal, but the disclosure is not so limited.

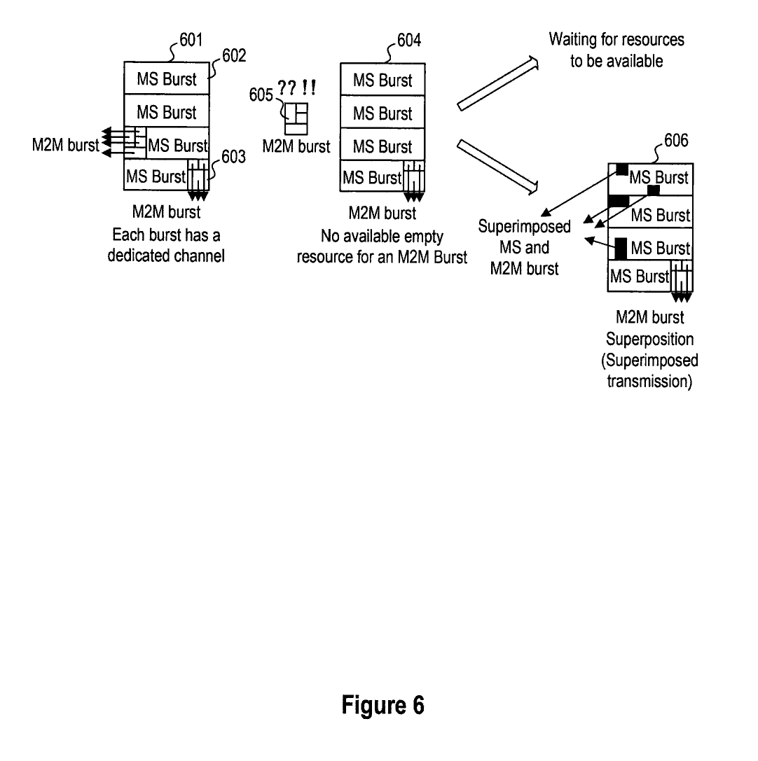

FIG. 6 depicts an exemplary solution to transmission of data on a heavily loaded channel in a wireless network, such as network 503. A channel resource allocation 601 diagrammatically illustrates allocation of available channel resources for transmitting mobile station data 602 and additional communication data, such as M2M data 603, and where M2M data 603 is transmitted in dedicated channels. A channel resource allocation 604 diagrammatically illustrates a situation in which there may be insufficient channel resources available for M2M data 605. In this situation, a transmitting device may wait until there are sufficient resources available, but this may not be a desirable solution. In some situations, the data for which there may be insufficient resources may be time sensitive data, and this data may need to be quickly communicated. For example, M2M data 605 could be data reporting an emergency, such as an earthquake. As a result, a more desirable solution may be to allocate the data as illustrated in a channel resource allocation 606. In channel resource allocation 606, M2M data 605 is broken into portions and the portions of the data may be superimposed on time-frequency resource blocks that may already be occupied by mobile station data. As a result, it would not be necessary to delay the transmission of time sensitive data.

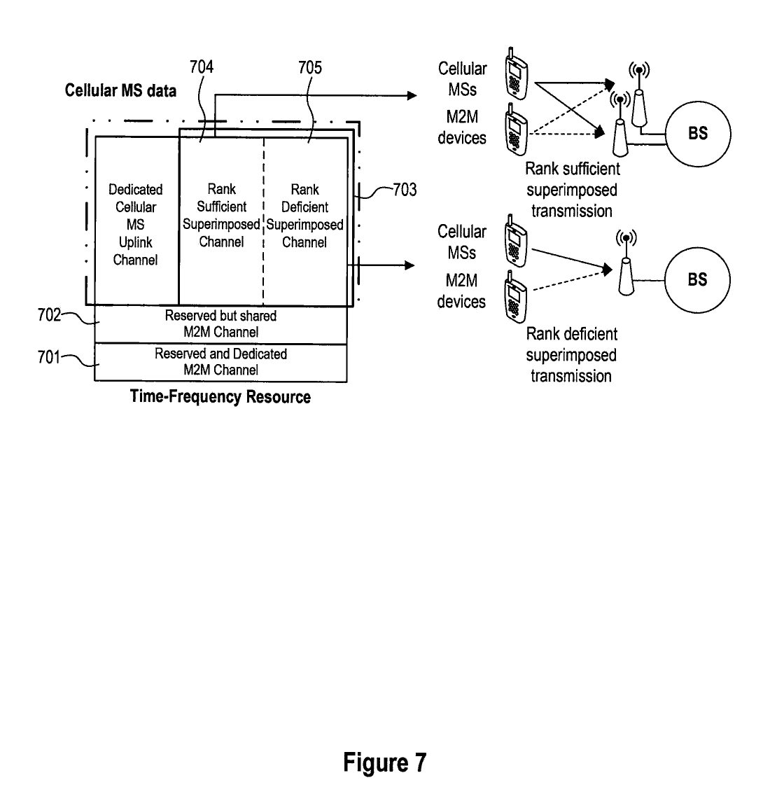

FIG. 7 illustrates a time-frequency diagram which shows exemplary radio channel access schemes of the present disclosure, and illustrates an example of how M2M devices may share radio channels with mobile stations. It is noted that FIG. 7 is for explanative purposes only and that a time-frequency resource block is not necessarily contiguous in the time or frequency domain. Additionally, the illustration of rank-sufficient and rank-deficient transmission in FIG. 7 is only for purposes of explanation.

In a reserved and dedicated channel access scheme 701, base station 504 of wireless network 503 may reserve one or more time-frequency channels for specific M2M service data of a single device. The result is that there may be no mutual interference between the M2M devices transmitting M2M service data and mobile stations transmitting mobile station data.

In a reserved and shared channel access scheme 702, base station 504 of wireless network 503 may reserve one or more time-frequency channels for M2M data, but many devices transmitting M2M data may share the one or more channels. As a result, there may be collisions between different M2M transmissions, but the mobile station transmissions would not interfere with the M2M transmissions.

In a superimposed channel access scheme 703, base station 504 may allocate M2M traffic to one or more channels which may already be occupied by mobile stations. As shown in FIG. 7, superimposed M2M data overlaps mobile station data in superimposed channel access scheme 703. There may be at least two different channel access schemes for superimposing M2M traffic on mobile station traffic. A first scheme may include a rank sufficient superimposed channel access scheme 704. In rank sufficient superimposed channel access scheme 704, there may be enough multiple-input and multiple-output (MIMO) channel spatial ranks to support additional data streams. A second scheme may include a rank deficient superimposed channel access scheme 705. In rank deficient superimposed channel access scheme 705, there may not be enough MIMO channel spatial ranks to support additional data streams. The term “rank” refers to the number of affordable spatial channels of a certain time-frequency resource block, and the number of ranks may depend on a number of available transmit antennas at a device transmitting data, a number of receive antennas at a device receiving the data, and propagation conditions. In a rank sufficient superimposed channel, the affordable number of spatial streams may be greater than the total number of transmitted streams in one or more time-frequency resource blocks. In a rank deficient superimposed channel, the affordable number of spatial streams may be less than the total number of transmitted streams in one or more time-frequency resource blocks. Superimposing channels may enhance the flexibility of channel allocation, especially when a wireless network may need to support transmission of a large number of M2M devices. That is, the total number of streams of mobile stations and M2M devices on one or more time-frequency resource blocks may be more than the MIMO channel ranks can support.

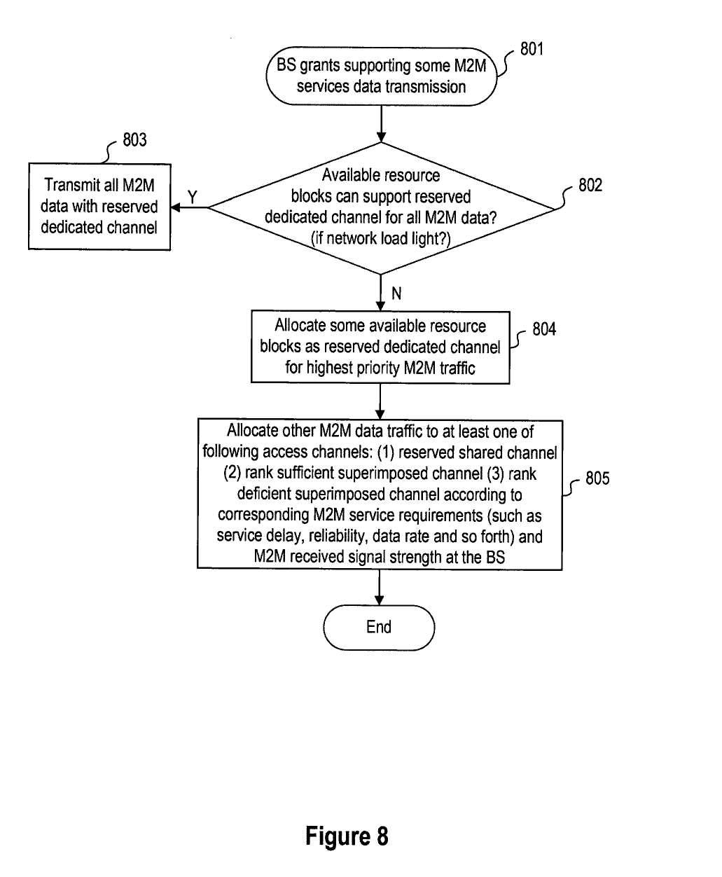

FIG. 8 depicts a flow diagram of an exemplary method 800 for carrying out embodiments disclosed herein. In step 801, a base station may grant support for some M2M data transmissions. In step 802, the base station may determine whether there are sufficient resource blocks to support a reserved and dedicated channel access scheme for all of the M2M data transmissions. If there are sufficient resource blocks (the network load is light, for example)(step 802-yes), then in step 803 all of the M2M data may be assigned to and transmitted on one or more reserved and dedicated channels.

If there are not sufficient resource blocks (the network load is heavy, for example)(step 802-no), then in step 804 the base station may determine which of the M2M traffic has a priority greater than a particular threshold priority. If there are available resource blocks, at least some of the available resource blocks may be assigned as one or more reserved and dedicated channels for M2M data traffic of a single device with a priority that exceeds the threshold priority. Priority of the M2M traffic may be indicated by a field within the M2M data itself, a header or footer of the M2M data, and/or by a separate command from an M2M device or other device. The priority threshold may be determined by ranking M2M data and setting a threshold such that there are sufficient network resources for transmitting all of the M2M data with priority above the threshold in one or more reserved and dedicated channels. Alternatively, the priority threshold may be pre-determined and pre-stored in a base station. Priority may also be established on the basis of network characteristics of the device transmitting the data and/or the service requirements of the data. For example, high priority data may be data that has requirements for high reliability, high data rate, and/or low delay. Of course, the disclosure is not so limited and any other suitable method of prioritizing data could be utilized with the present disclosure.

Regardless of whether some of the M2M data traffic is allocated to one or more reserved and dedicated channels in step 804, the remainder of the M2M data traffic, if any, may be allocated in step 805. In step 805, service requirements of the remainder of the M2M data traffic and/or network characteristics of the M2M device transmitting the M2M data traffic may be determined. This remainder of the M2M data traffic may then be allocated to one of the other channel access schemes discussed above with reference to FIG. 7 based on the M2M data traffic service requirements and/or the network characteristics associated with the M2M device. That is, the remainder of the M2M data traffic may be allocated to at least a reserved and shared channel access scheme, a rank sufficient superimposed channel access scheme, and/or a rank deficient superimposed channel access scheme according to the service requirements and/or network characteristics.

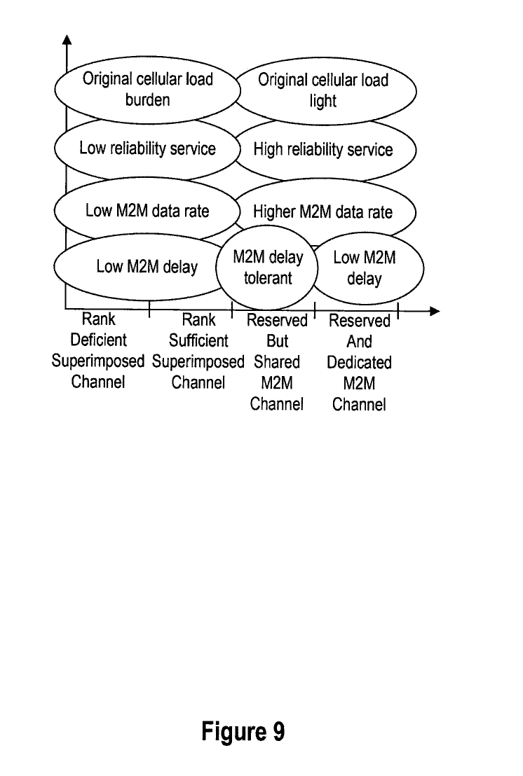

The channel access types of the present disclosure may provide different link qualities and transmission delays. In order to efficiently utilize these differences, M2M traffic may be allocated on the basis of M2M data traffic service requirements and/or network characteristics, as noted above. FIG. 9 illustrates some of the characteristics a base station 504 may monitor and take into consideration in selecting a particular channel allocation scheme. In general, a base station 504 may allocate one or more resource blocks as one or more reserved and dedicated channels for all M2M traffic if there are sufficient available resource blocks. Otherwise, the base station may allocate some of the resource blocks as one or more reserved and dedicated channels for M2M traffic having priority that exceeds a priority threshold. The remaining M2M data traffic may then be allocated to the reserved shared channel, rank sufficient superimposed channel, and/or rank deficient superimposed channel, according to corresponding M2M service requirements and/or network characteristics. As a result, superimposed channels may be adopted for M2M traffic with low reliability, low data rate (or small burst size), and/or low delay service requirements. Superimposed channels may also be adopted for delay stringent M2M data to avoid long waiting times for reserved M2M channels to become available.

M2M service requirements considered by base station 504 may include, for example, service time delay requirements and/or transmission reliability (or burst error rate) requirements. Base station 504 may also consider burst size, packet size, and/or data rate of the M2M data. However, the present disclosure is not so limited and other data characteristics and/or requirements could be considered in allocating the data to different types of channels as noted above. On the basis of various service requirements, base station 504 may determine how to allocate M2M data to the aforementioned channel access schemes in order to meet, in full or in part, the various service requirements.

Network characteristics considered by base station 504 in determining how to allocate M2M data traffic may include channel load characteristics and/or signal strength characteristics. Channel load characteristics may include determining whether the network load is burdensome. If the network load is low, base station 504 may assign M2M data to a reserved and dedicated channel access scheme and/or a reserved and shared channel access scheme. When the network load is heavy, base station 504 may assign M2M data to a superimposed channel access scheme, so that the channel resources can be shared by original cellular mobile station traffic and M2M devices, thus avoiding delays in waiting for reserved M2M channels to become available.

Signal strength characteristics considered by the base station may include received signal strength indication (RSSI) of M2M or mobile station data traffic. The RSSI may depend on the channel gain (e.g., large scale and small scale fading) and/or transmission power of the M2M device or mobile station. The M2M or mobile station data signal strength may be measured by base station 504 directly, and/or may be fed back by M2M devices or mobile stations through a feedback channel.

Once the network resources have been allocated by the base station, the base station sends a resource allocation policy to one or more M2M devices and/or other devices that transmit service data. The resource allocation policy defines the resource allocation determined by the base station and instructs the one or more devices to transmit the service data according to the determined resource allocation.

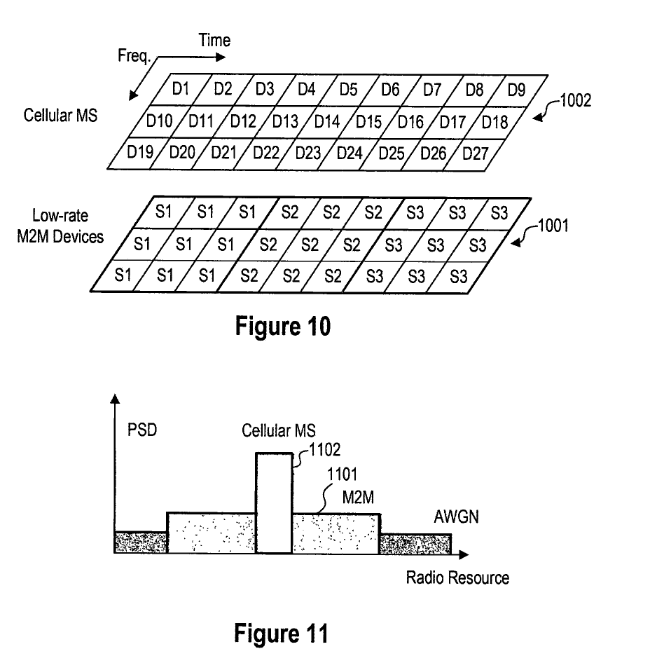

FIG. 10 illustrates an exemplary embodiment for superimposing M2M data on mobile station data. In general, burst sizes of M2M traffic may be small compared to data packet sizes of mobile station communications, such as cellular voice and data communications. Additionally, low power transmission may be desirable for M2M transmission, because low power transmission provides longer battery life for battery-powered M2M devices. Therefore, M2M communication may have low data rate and low power characteristics. As a result, the data may be superimposed on original mobile station data symbols, even in rank deficient channel conditions. In the embodiment illustrated in FIG. 10, data symbols of a low data rate and low power M2M data transmission 1001 (represented by S1, S2, and S3) may be allocated repeatedly and redundantly to multiple time-frequency resource units, which may also have been assigned to high rate and high power mobile station data 1002 (represented by D1-D27). As illustrated, the M2M data may be repeatedly and redundantly spread over more resource units than the high rate mobile station data. For example, each of M2M data S1, S2, and S3 is spread over nine resource units. This is also illustrated in FIG. 11, where it is shown that M2M data 1101 may have less power than mobile station data 1102, and may be spread over a wider spectrum of time-frequency resource units than mobile station data 1102.

If a receiver of base station 504 is equipped with more receive antennas than required by superimposed streams and/or if the channel is in a rich scattering condition, the received mobile station data and M2M data may be assigned to a rank sufficient superimposed scheme and the data may be jointly detected by conventional MIMO detectors, such as Vertical-Bell Laboratories Layered Space-Time (V-BLAST) or sphere decoders. In a rank sufficient superimposed scheme, the receiver may simultaneously detect mobile station and M2M data even if the M2M data is not spread to multiple time-frequency resource units.

If a receiver of base station 504 is equipped with fewer receive antennas than required by the superimposed streams, and/or if the channel is in poor condition (a non-rich scattering environment, for example), the low-rate M2M data may be spread to L time-frequency resource units. For instance, in a scenario in which base station 504 only has one receive antenna and mobile station and M2M devices are each transmitting a single stream in the same superimposed time-frequency channel, the signal received at base station 504 may be represented mathematically as:

$${y}_{0} = {h}_{d , 0} {d}_{0} + {h}_{s , 0} s + {w}_{0}$$

$$⋮$$

$${y}_{L - 1} = {h}_{d , L - 1} {d}_{L - 1} + {h}_{s , L - 1} s + {w}_{L - 1}$$

$$y = {H}_{d} d + {sh}_{s} + w$$

where y=[y₀, . . . , y_{L-1}]^{T}, d=[d₀, . . . , d_{L-1}]^{T}, and w=[w₀, . . . , w_{L-1}]^{T} represent the vector form of the received superimposed signal, mobile station transmitted signal, and thermal noise, respectively. The symbol s denotes the M2M transmitted data that has been spread over L resource units. The vector forms H_{d}=dia_{g}{h_{d,0}, . . . , h_{d,L-1}} and hₛ=h_{s,0}, . . . , h_{s,L-1}]^{T} represent the gains of a channel between a base station and a mobile station and of a channel between a base station and an M2M device, respectively.

Mobile station data and M2M data may be detected by base station 504 using a maximum likelihood detector employing a maximum likelihood detection algorithm, such as

$${\tilde{x}}^{*} = arg {max}_{\tilde{x}} log ( p ( y \vert \tilde{x} ) ) {}^{with AWGN assumption} \\ \begin{matrix}{\tilde{x}}^{*} = arg {min}_{\tilde{x}} {\sum }_{n = 0}^{L - 1} {\vert {y}_{n} - {h}_{d , n} {d}_{n} - {sh}_{s , n} \vert}^{2} \\ = arg {min}_{\tilde{x}} {\sum }_{n = 0}^{L - 1} ( \begin{matrix}{\vert {y}_{n} - {h}_{d , n} {d}_{n} \vert}^{2} + {\vert {sh}_{s , n} \vert}^{2} - \\ 2 Re \{ ( {y}_{n} - {h}_{d , n} {d}_{n} ) {s}^{*} {h}_{s , n}^{*} \}\end{matrix} )\end{matrix}$$

where \tilde{x}=[d s]^{T}, and \tilde{x}* is the maximum likelihood solution of \tilde{x}, and AWGN is an acronym for additive white Gaussian noise. Nevertheless, maximum likelihood detection may be computationally intense.

Instead of, or in addition to, a maximum likelihood detector, base station 504 may utilize a successive interference cancellation (SIC) based detector to decode both the mobile station and M2M data streams. This may be possible, because the low rate M2M data may be spread over L time-frequency resource units and the transmit power of M2M data on each time-frequency resource unit may be lowered, so that the interference induced by the M2M data on the mobile station data may be mitigated. Receivers of base station 504 may first treat the low power data as thermal noise and decode high power M2M data. Then, the decoded high power mobile station data may be subtracted from the received superimposed signal. Finally, the low rate and low power M2M data may be decoded. This procedure may be conducted iteratively to obtain better performance.

Base station 504 may also make further determinations of how to allocate M2M data in order to mitigate interference effects caused by transmitting the low-rate and low-power M2M data on the same resource blocks occupied by mobile stations. In one example, base station 504 may select one or more resource blocks for superposition based on the relative strength of a mobile station received signal strength to an M2M received signal strength. For instance, if a received signal strength of a mobile station transmission within one or more resource blocks exceeds by a certain threshold a received signal strength of a M2M transmission, base station 504 may select the one or more resource blocks for superposition. Doing so may minimize the M2M signal-induced interference on the mobile station data. The threshold may be a pre-determined difference between received signal strengths, may be a minimum ratio between the received signal strengths, or may be any other form of comparison.

In a second example, base station 504 may select one or more resource blocks for superposition based on a number of data streams being transmitted in the one or more resource blocks. For instance, base station 504 may select one or more resource blocks where the number of mobile station data streams being transmitted on the one or more resource blocks is below a threshold. In one embodiment, the threshold may be set to the number of receive antennas at base station 504. In another embodiment, the threshold may be a predetermined number. In yet another embodiment, resource blocks may be ranked based on the number of data streams transmitted in each resource block, and the base station may select one or more resource blocks with the least number of data streams first. Thus, by selecting resource blocks on the basis of the number of data streams being transmitted in each resource block, base station 504 may impose a preference for rank-sufficient superimposed channels over rank-deficient superimposed channels.

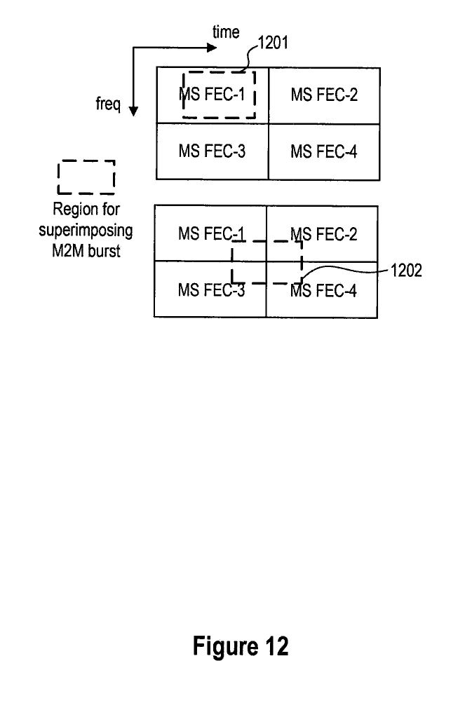

FIG. 12 illustrates a third example of selecting resource blocks. In this example, base station 504 may select one or more resource blocks based on a number of forward error correction (FEC) blocks of mobile station data that are within the one or more resource blocks. For instance, base station 504 may select one or more resource blocks based on whether the number of FEC blocks within the one or more resource blocks is greater than a threshold value. The threshold value may be a predetermined value. Alternatively, the resource blocks may be ranked based on how many FEC blocks are in each resource block, and the base station may select one or more resource blocks containing the greatest number of FEC blocks first. The FEC blocks do not need to be fully contained within a resource block in order to be counted in the number of FEC blocks. For example, in FIG. 12, resource block 1202 contains fragments of four different FEC blocks, but does not contain an entire FEC block. Nevertheless, resource block 1202 is selected over a resource block that contains fewer FEC blocks, even if they are full FEC blocks, such as block 1201. By allocating M2M data to resource blocks with multiple FEC blocks of mobile station data, the interference caused by superimposing M2M data on each FEC block can be reduced.

One of ordinary skill should now recognize that any combination of the aforementioned examples for determining which resource blocks to select for superposition could be used. For instance, base station 504 could select one or more resource blocks on the basis of signal power, data stream number, and number of FEC blocks. Alternatively, base station 504 could employ two of the first, second, and third examples described above, or one of those three examples. Base station 504 could employ all or some of those three examples in any order, and may employ one of more of the examples to select from resource blocks previously selected using another example for resource block selection. Nevertheless, the disclosure is not so limited.

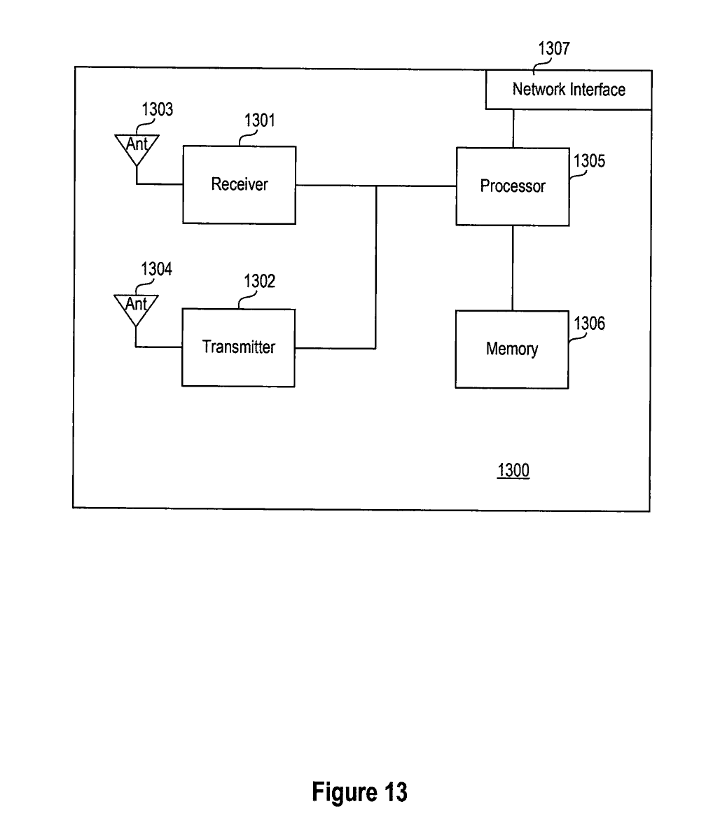

FIG. 13 depicts an exemplary base station 1300 for transmitting and receiving data within wireless network environment 500. Base station 1300 may be a macro cell, micro cell, pico cell, or femto cell base station. Data signals transmitted from mobile stations 501, M2M devices 502, and/or other network may be received at an antenna 1303 and processed at a receiver block 1301. Data signals may be processed at a transmitter block 1302 and transmitted from an antenna 1304 to mobile stations 501, M2M devices 502, and/or other network devices. A processor 1305 may be any suitable type of processor. The functions of processor 1305 may be provided by a single dedicated processor or by a plurality of processors. Processor 1305 may be coupled to receiver block 1301, transmitter block 1302, and a memory 1306. Processor 1305 may also be coupled to a network interface 1307 for receiving and/or transmitting commands and information from and/or to the processor. Processor 1305 may receive and/or transmit commands from/to other devices over wired networks, such as Universal Serial Bus (USB), Ethernet, Internet, FireWire, twisted-pair, coaxial cable, or other wired networks. Processor 1305 may alternatively receive/transmit commands wirelessly over cellular, satellite, IEEE 802.11, terrestrial, or other wireless networks. Processor 1305 may also be coupled to a computer providing a user interface allowing input of information and commands to the processor and/or allowing output of information and commands in a human-readable form.

Memory 1306 may be configured to store instructions that, when executed by processor 1305, carry out the exemplary steps of the disclosed embodiments. Memory 1306 may also store an operating system, applications, and/or parameters. Data stored on memory 1306 may be stored in a single dedicated memory, or a plurality of memory devices. Memory 1306 may be any type of physical, non-transient memory, volatile or non-volatile, including, but not limited to, random access memory (RAM), read-only memory (ROM), magnetic storage, semiconductor storage, optical disc storage, and/or magneto-optical disc storage.

Those skilled in the art will appreciate that the embodiments of the present disclosure, as described above, could be used in a variety of applications. The systems and methods for adaptive radio channel allocation may be employed in a cellular environment, WiMAX environment, or any number of other wireless environments. Although disclosed as being employed in an environment where M2M devices and mobile stations coexist, the disclosure is not so limited. In addition to or instead of M2M devices, other devices capable of transmitting and receiving information over a wireless network may coexist with mobile stations on the network. These other devices may include personal computers, servers, PDAs, tablet computers, netbooks, e-book readers, mobile phones, smart phones, or any other device capable of transmitting over a wireless network. The embodiments for adaptive radio channel allocation of the present disclosure may be implemented to grant radio channel access to any one or more of these other devices.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

1. A method for adaptive channel access in a wireless network, the method comprising:
monitoring one or more characteristics of the wireless network;
assigning, by a base station of the wireless network, a channel access scheme for providing channel access to service data, wherein at least a portion of the service data is assigned to one of a reserved shared channel access scheme and a superimposed channel access scheme based on the one or more characteristics of the network and one or more requirements of the service data;
allocating resources of the network according to the assigned channel access scheme, wherein the resources are allocated in resource blocks; and
causing the service data to be transmitted using the allocated resources.

2. The method of claim 1, wherein upon assignment to a reserved shared channel access scheme, the causing further includes transmitting the portion of the service data on one or more channels that are reserved for transmission of service data, but shared among network devices.

3. The method of claim 1, wherein upon assignment to a superimposed channel access scheme, the allocating further includes allocating the service data to one or more channels already transmitting mobile station data and superimposing the service data on the mobile station data.

4. The method of claim 1, wherein assigning to a superimposed channel access scheme includes assigning to one of a rank sufficient superimposed channel access scheme and a rank deficient superimposed channel access scheme.

5. The method of claim 3, wherein superimposing the service data on the mobile station data includes spreading the service data over selected resource blocks of a channel.

6. The method of claim 5, wherein the selected resource blocks are selected by selecting resource blocks having signal power higher than a determined threshold.

7. The method of claim 5, wherein the selected resource blocks are selected by selecting resource blocks transmitting a number of data streams lower than a determined threshold.

8. The method of claim 5, wherein the selected resource blocks are selected by selecting resource blocks with more forward error correction (FEC) blocks than a determined threshold.

9. The method of claim 1, wherein the one or more characteristics of the network include at least one of a channel load and a received signal strength.

10. The method of claim 1, wherein the one or more requirements of the service data correspond to at least one of service delay, burst size, packet size, data rate, transmission reliability, and burst error rate.

11. A base station providing adaptive radio channel access in a wireless network, the base station comprising:
a memory that stores instructions; and
a processor that, when executing the instructions, is configured to:
monitor one or more characteristics of the wireless network;
assign a channel access scheme for providing channel access to service data, wherein at least a portion of the service data is assigned to one of a reserved shared channel access scheme and a superimposed channel access scheme based on one or more characteristics of the network and one or more requirements of the service data;
allocate resources of the network according to the assigned channel access scheme, wherein the resources are allocated in resource blocks; and
cause the service data to be transmitted using the allocated resources.

12. The base station of claim 11, wherein upon assigning a portion of the service data to a reserved shared channel access scheme, the processor is further configured to cause the portion of the service data to be transmitted on one or more channels that are reserved for transmission of service data, but shared among network devices.

13. The base station of claim 11, wherein upon assigning the service data to a superimposed channel access scheme, the processor is further configured to:
allocate the service data to one or more channels already transmitting mobile station data; and
cause the service data to be superimposed on the mobile station data.

14. The base station of claim 11, wherein configuring the processor to assign the service data to a superimposed channel access scheme further includes configuring the processor to assign the service data to one of a rank sufficient superimposed channel access scheme and a rank deficient superimposed channel access scheme.

15. The base station of claim 14, wherein configuring the processor to assign the service data to a superimposed channel access scheme further includes configuring the processor to superimpose the service data on the mobile station data by spreading the service data over selected resource blocks of a channel.

16. The base station of claim 15, wherein configuring the processor to assign the service data to a superimposed channel access scheme further includes configuring the processor to select resource blocks of signal power higher than a determined threshold for superimposing.

17. The base station of claim 15, wherein configuring the processor to assign the service data to a superimposed channel access scheme further includes configuring the processor to select resource blocks already transmitting a number of data streams lower than a determined threshold for superimposing.

18. The base station of claim 15, wherein configuring the processor to assign the service data to a superimposed channel access scheme further includes configuring the processor to select resource blocks with more forward error correction (FEC) blocks than a determined threshold for superimposing.

19. The base station of claim 11, wherein the one or more characteristics of the network include at least one of a channel load and a received signal strength.

20. The base station of claim 11, wherein the one or more requirements of the service data correspond to at least one of service delay, burst size, packet size, data rate, transmission reliability, and burst error rate.

21. A method for adaptive radio channel access in a wireless network, the method comprising:
monitoring one or more characteristics of the wireless network;
assigning, by a base station of the wireless network, a channel access scheme for providing channel access to service data based on the one or more characteristics of the network and one or more requirements of the service data, wherein the assigning includes:
assigning the service data to one or more reserved and dedicated channels if the one or more network characteristics indicate sufficient bandwidth to transmit the service data on one or more reserved channels dedicated to a network device, and
determining an alternative channel assignment if the one or more network characteristics indicate insufficient bandwidth to transmit the service data on one or more reserved channels dedicated to a network device, wherein the determining further includes:
assigning a portion of the service data to one or more reserved channels dedicated to a network device when the one or more requirements indicate that the portion of the service data has a priority greater than a determined threshold, and
assigning a remainder of the service data to one of a reserved shared channel access scheme and a superimposed channel access scheme based on the one or more characteristics of the network and the one or more requirements of the service data;
allocating resources of the network according to the assigned channel access scheme, wherein the resources are allocated in resource blocks; and
causing the service data to be transmitted using the allocated resources.
